(19) United States
(12) Patent Application Publication
(10) Pub. No.: US 2015/0220394 A1
(43) Pub. Date: Aug. 6, 2015

(54) MEMORY SYSTEM AND METHOD OF CONTROLLING MEMORY SYSTEM

(71) Applicant: Kabushiki Kaisha Toshiba, Minato-ku (JP)

(72) Inventor: Hiroaki TANAKA, Hadano-shi (JP)

(73) Assignee: Kabushiki Kaisha Toshiba, Minato-ku (JP)

(21) Appl. No.: 14/279,485

(22) Filed: May 16, 2014

Related U.S. Application Data
(60) Provisional application No. 61/935,110, filed on Feb. 3, 2014.

(51) Int. Cl. G06F 11/10

(52) U.S. Cl. CPC G06F 11/1076

(57) ABSTRACT

According to an embodiment, a controller performs a process corresponding to processing of a second command when the second command is received from a host device before a first time passes after an end of processing corresponding to a first command received from the host device, and executes patrol read to read data stored in a nonvolatile memory continuously in predetermined units when no command is received from the host device before the first time passes.

### CROSS-REFERENCE TO RELATED APPLICATIONS

This application is based upon and claims the benefit of priority from U.S. Provisional Patent Application No. 61/935,110, filed on Feb. 3, 2014; the entire contents of which are incorporated herein by reference.

### FIELD

Embodiments described herein relate generally to a memory system including a nonvolatile memory and a method of controlling the memory system.

### BACKGROUND

In a storage system including a nonvolatile memory such as a flash memory, maintenance processing called patrol read is performed, which reads and tests data stored in the nonvolatile memory in predetermined units.

The patrol read is executed between processing of commands from the host device such as read and write, as it is intended to be invisible from the host device. However, if a said command is issued during processing of a unit of reading and testing caused by said patrol read, the command processing is caused to wait until said reading and testing ends. On the other hand, if the command processing is performed too preferentially, the storage system cannot complete the entire patrol read process within a predetermined period.

Accordingly, there has been desired a method for reducing latency times of both processing of a command from the host device and processing of the patrol read and improving the efficiency of both of them.

### BRIEF DESCRIPTION OF THE DRAWINGS

FIG. 1 is a functional block diagram of an internal configuration of a memory system according to a first embodiment;

FIG. 2 is a time chart of an operation of a comparative example;

FIG. 3 is a time chart for explaining an operation of the first embodiment;

FIG. 4 is a time chart for explaining an operation of the first embodiment;

FIG. 5 is a flowchart for explaining an operation of the first embodiment;

FIG. 6 is a time chart for explaining an operation of the first embodiment;

FIG. 7 is a functional block diagram of an internal configuration of a memory system according to a second embodiment;

FIG. 8 is a time chart for explaining an operation of the second embodiment; and

FIG. 9 is a flowchart for explaining an operation of the second embodiment.

### DETAILED DESCRIPTION

According to the present embodiment, a memory system includes a nonvolatile memory and a controller configured to control the nonvolatile memory. The controller is configured to perform a process corresponding to a second command when the second command is received from a host device before a first time passes after an end of processing corresponding to a first command received from the host device. The controller is configured to execute patrol read to read data stored in the nonvolatile memory continuously in predetermined units when no command is received from the host device before the first time passes.

Exemplary embodiments of a memory system and a method of controlling the memory system will be explained below in detail with reference to the accompanying drawings.

The present invention is not limited to the following embodiments.

### First Embodiment

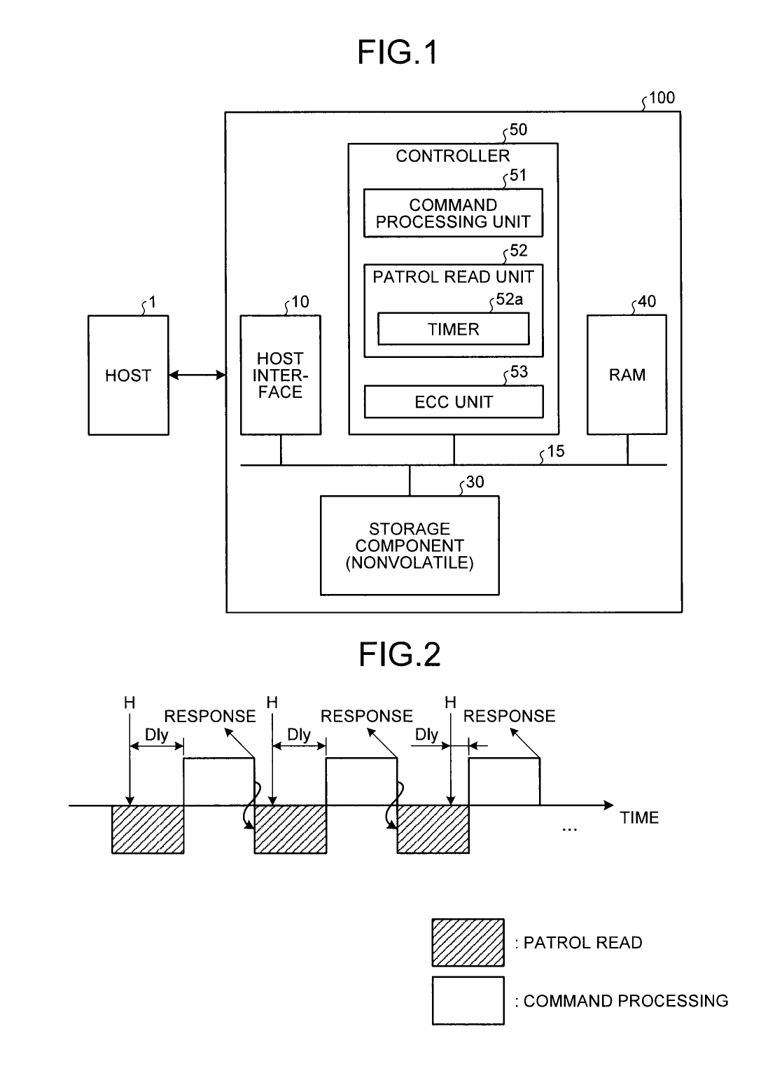

FIG. 1 is a block diagram of a configuration example of a memory system 100 according to a first embodiment. The memory system 100 is connected to a host device (hereinafter, “host”) 1 via a host interface 10 and functions as an external storage device of the host 1. The host 1 is, for example, a personal computer, a mobile phone, or an imaging device, and so on.

The memory system 100 includes the host interface 10, a storage component 30 being a nonvolatile memory, a random access memory (RAM) 40 being a volatile semiconductor memory capable of higher-speed access than the storage component 30, a controller 50, and a bus 15.

The host interface 10 performs communication of a command, data, a status report, and the like with the host 1.

The storage component 30 is nonvolatile memory composed of flash memories such as NAND flash memories. The storage component 30 stores therein user data designated by the host 1. The storage component 30 also stores therein management information managed by the RAM 40 for backup. The NAND flash memory includes one chip or a plurality of memory chips. Each of the memory chips has a plurality of memory cells arrayed in a matrix. The memory cell array is configured by arranging a plurality of blocks being units of data erasure. Each of the blocks includes a plurality of pages. The pages are units of data writing and data reading.

The storage component 30 is not limited to a nonvolatile semiconductor memory such as the NAND flash memory and a nonvolatile memory capable of storing data therein, such as a three-dimensional structure flash memory, a ReRAM (Resistance Random Access Memory), a FeRAM (Ferroelectric Random Access Memory), or a hard disk can be adopted therefor.

The RAM 40 includes a storage area in which management information is stored. The management information is, for example, a mapping table that indicates a relation between logical addresses designated by the host 1 and storage locations (physical addresses) on the storage component 30 and the like. As the RAM 40, a volatile SRAM (Static Random Access Memory), a DRAM (Dynamic Random Access Memory), or the like is adopted. The management information is loaded to the RAM 40 from the storage component 30 at the time of startup or the like.

The ram 40 may also include a write buffer or a read buffer, which serve as a temporary storing area for data written by the host 1 that are to be stored in the storage component 30 or data read from the storage component 30 that are to be sent to the host 1.

The controller 50 has a command processing unit 51, a patrol read unit 52, and an error correction (ECC) unit 53.

The command processing unit 51 performs processing according to various commands issued by the host 1 via the host interface 10. The command processing include a process of reading data from the storage component 30, a process of writing data in the storage component 30, and the like. The command processing unit 51 also updates the management information managed in the RAM 40 if necessary.

The ECC unit 53 calculates error-correcting code for write data to the storage component 30, adds the ECC to the write data, and outputs resultant data to the storage component 30. The ECC unit 53 also corrects data read from the storage component 30 using the ECC if necessary.

The ECC unit 53 has a plurality of ECC units having different error correction capabilities. For example, the ECC unit 53 has a first-level ECC unit, a second-level ECC unit, and a third-level ECC unit having three different error correction capabilities, respectively. The second-level ECC unit has a higher error correction capability than the first-level ECC unit and the third-level ECC unit has a higher error correction capability than the second-level ECC unit. Therefore, when the first-level ECC unit cannot correct an error, the second-level ECC unit performs error correction and, even when the second-level ECC unit cannot correct the error, the third-level ECC unit performs error correction.

The patrol read unit 52 executes periodically patrol read, which is a data test of reading data stored in the storage component 30 in predetermined units and testing whether the read data is normal or abnormal. The patrol read is an operation to confirm whether data recorded in the storage component 30 is likely to lose due to deterioration of a medium and is performed by the memory system 100 voluntarily without being instructed from the host 1. The test within the patrol is, for example, to apply the first-level ECC unit to data read from the storage component 30 and to determine if above ECC unit succeeds error correcting. If the ECC unit failed error correcting, the higher-level ECC unit will be applied and the data consistency will be kept, however the data is no more regarded as ‘normal’, but regarded as ‘abnormal’. Another method of testing is to determine the abnormality by using the number of bits that are corrected by first-level ECC unit. There may yet be other methods to test the read data, however the testing methods are not within the scope of this invention and readers of the normal art can freely combine any testing methods with the technology explained in this patent.

The patrol read unit 52 executes the patrol read for the entire area in which valid data is recorded in the storage component 30. The patrol read for the entire area in which valid data is recorded is executed each time a patrol read cycle time Ta passes. The patrol read cycle time Ta is counted in a time when the memory system 100 is powered on and is set to tens of hours or hundreds of hours, for example. When a command such as read or write is received from the host 1 while performing the patrol read, the patrol read is suspended for processing of the command from the host 1 to be performed by the command processing unit 51, and the patrol read is resumed after that.

The patrol read unit 52 reads data in small predetermined units and causes the ECC unit 53 to check the read data. While the predetermined unit is set to one page in the present embodiment, another unit can be used as the unit of the patrol read. In the patrol read in a page unit, when an error cannot be corrected by the first-level ECC unit in the ECC unit 53, the patrol read unit 52 causes the second-level ECC unit and then the third-level ECC unit to perform error correction to correct the error in the data. The data that has been read from a certain location of the storage component 30, failed error correcting by the first-level ECC unit and succeeded error correcting by the second or third-level ECC unit will be re-stored to another location of the storage component 30. The data location of the data has been stored originally before the error correction, will then be invalidated.

FIG. 2 is a time chart schematically illustrating patrol read of a comparative example. Each of hatched rectangles indicates a time period while the storage system performs reading one unit (a page unit) of data as patrol read. Each of unhatched rectangles indicates a time period while the storage system performs processing of a command received from the host 1, such as read or write. Although the execution time of each processing differs each other in actual, all rectangles have a fixed length in the figures for sake of simplicity. Each of the arrows attached with “H” indicates a time point when a command from the host 1 is received. When a command is received from the host 1 in the middle of the patrol read, the patrol read in a page unit already started cannot be stopped and the command processing is caused to wait until end of read of each page unit, which is denoted by the delay time Dly. In the patrol read of the comparative example, when the processing of a command from the host 1 ends, the patrol read of the next page is started immediately. Accordingly, in the comparative example, even when a command from the host 1 is received immediately after the command processing ends, the host command is always caused to wait.

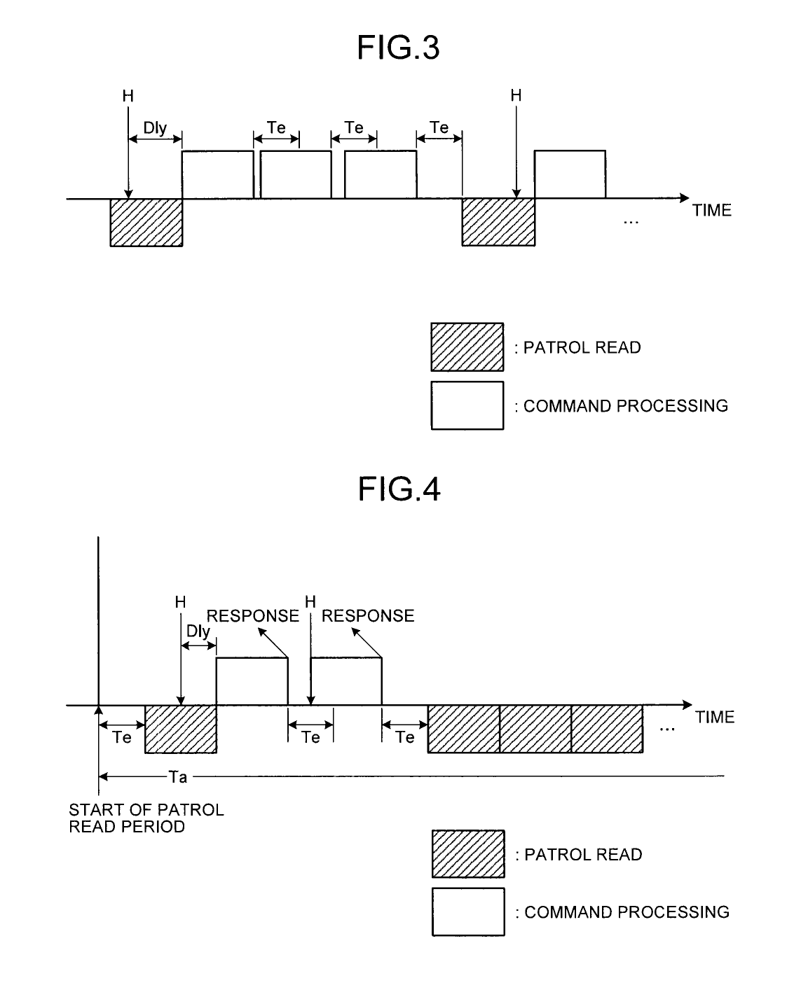

Generally, after issuance of a command, the host 1 is likely to issue the next command in a short time. Therefore, in the first embodiment, the controller 50 does not start the next patrol read until a grace time Te of the patrol read passes after host command processing ends and, when a command from the host 1 is received before passage of the grace time Te, the controller 50 immediately performs processing of the host command, as shown in FIG. 3. After the grace time Te has passed from the end of the host command processing, the patrol read is continuously executed unless a command from the host 1 is received. In the first embodiment, the grace time Te is a preset fixed time.

FIG. 4 illustrates another control example of the first embodiment. In FIG. 4, the control is performed as follows.

A first process of the patrol read is not started until the grace time Te passes from a start point of the patrol read cycle time Ta.
The patrol read is not resumed after host command processing ends and before the grace time Te passes.
After the predetermined grace time Te passes from the end of the host command processing, the patrol read is continuously executed unless a command from the host 1 is received.

For this purpose, the patrol read unit 52 has a timer 52a that counts the grace time Te from a time point when the host command processing ends.

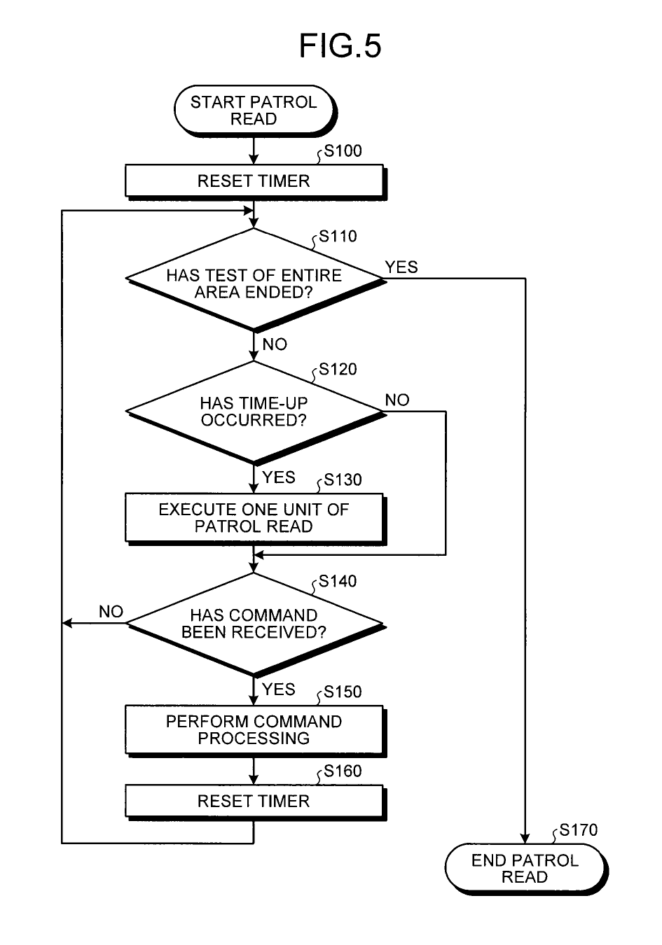

FIG. 5 is a flowchart of an operation procedure performed by the controller 50 in the first embodiment. When the patrol read cycle time Ta is started, the timer 52a is reset and counting of the timer 52a is started (Step S100). The controller 50 determines whether a test of the entire area of patrol read targets has ended (Step S110) and, when the test of the entire area has not ended, determines whether a state where a count of the timer 52a exceeds the predetermined grace time Te, which is hereinafter referred to as “time-up” of the timer 52a, has occurred (Step S120).

When the time-up of the timer 52a does not occur, the controller 50 determines whether a command from the host 1 has been received (Step S140). When a command has been received from the host 1 before the time-up of the timer 52a occurs (Yes at Step S140), the controller 50 performs command processing immediately (Step S150) and resets the timer 52a after the end of the command processing (Step S160). After the reset, the timer 52a restarts the time counting operation.

When no command has been received at the determination at Step S140, the controller 50 then repeats a loop of Steps S110, S120, and S140 until the time-up of the timer 52a occurs at Step S120 or until a command is received at Step S140.

When the time-up of the timer 52a has occurred at Step S120, the controller 50 executes one unit of the patrol read (the patrol read corresponding to one page, for example) (Step S130).

After this patrol read is executed, a loop of Steps S140, S110, S120, and S130 is repeated as long as a state where no command is received from the host 1, because the timer 52a keeps time-up until reset timer. Accordingly, the patrol read is continuously executed.

When the command processing is performed at Step S150, the controller 50 initializes the timer 52a at Step S160, thereby restarting counting of the grace time Te. Then, in a state where the time-up of the timer 52a has not occurred (No at Step S120) and when a command from the host 1 has been received (Yes at Step S140), the controller 50 immediately performs the command processing (Step S150). When the time-up of the timer 52a is detected (Yes at Step S120), the controller 50 executes one unit of the patrol read (Step S130). By repeating these processes to end the patrol read of the entire area of the test targets (Step S110), the patrol read of the patrol period ends (Step S170). When the counting of the patrol read cycle time Ta ends before the patrol read of the entire area of the test targets ends, a new patrol read of the next cycle is started from the beginning.

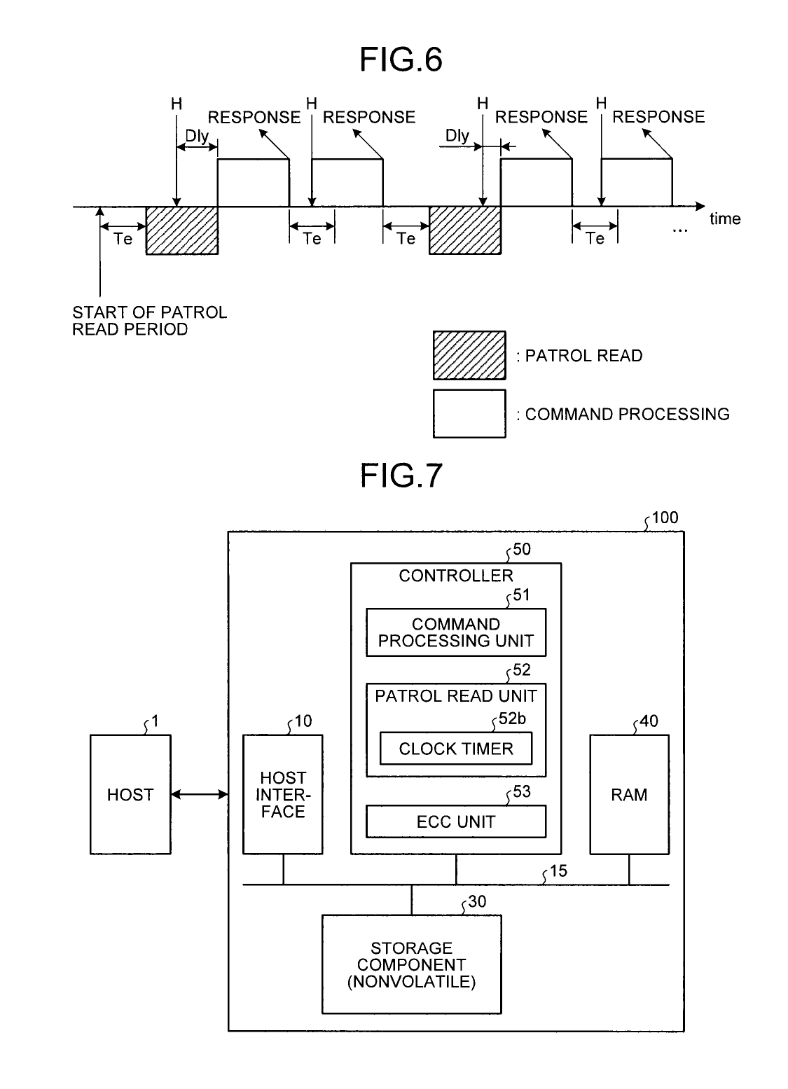

As described above, in the first embodiment, starting of the next patrol read is prevented until the predetermined grace time Te passes after the end of host command processing. Therefore, as shown in FIG. 6, if the host sends commands intermittently, the storage system can start processing for each of the commands with no latency time, because the storage system waits for a new command from the host for a grace time Te after finishing processing of a previous command, while the first command may have to wait for a latency times of Dly before start processing of host commands because the patrol read may already in progress. On the other hand, as long as no command is received from the host 1, after the time-up of the timer 52a has occurred, the patrol read is continuously executed as shown in FIG. 4. Therefore, the patrol read can be continuously executed with no latency time and one period of the patrol read can be ended early. In this way, in the first embodiment, the latency times of both processes of the command processing and the patrol read can be reduced and the both processes can be performed

### Second Embodiment

FIG. 7 is a block diagram of a configuration example of the memory system 100 according to a second embodiment. In the second embodiment, a clock timer 52b serving as a periodic timer that periodically generates an event is used instead of the timer 52a in the first embodiment. The clock timer 52b generates an event such as an interrupt at a fixed interval (once a second, for example) and is widely used also for other time managements that do not require high accuracy in the memory system 100.

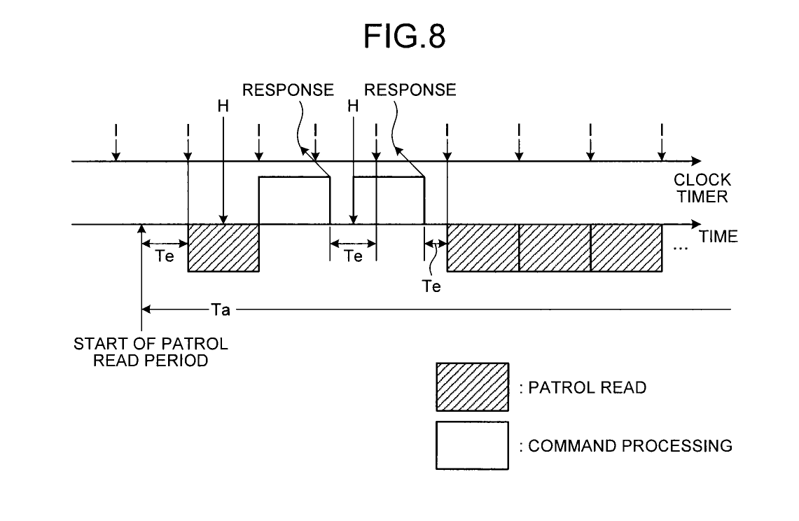

FIG. 8 is a time chart schematically illustrating patrol read in the second embodiment. Each of the arrows attached with “I” indicates a time point of periodic event occurrence from the clock timer 52b. In the second embodiment, the grace time Te begins with the end of host command processing or with the beginning of a certain patrol read cycle time Ta if there is no host command processing at the time. And the grace time Te ends with the first event from the clock timer 52b or the first command receiving from the host 1 after the beginning of Te. Accordingly, the grace time Te in the second embodiment is variable even if there is no command received from the host 1. For the engineers with normal art, it will be easy to modify the end of grace time Te with second or third events from the clock timer 52b from the beginning of Te if he or she wants Te to be longer than the duration time of clock timer 52b.

The first patrol read within a certain patrol read cycle time Ta begins just after the first grace time Te ends without receiving command from the host 1 as well as the first embodiment.

The patrol read is not resumed until the grace time Te ends without receiving command from the host 1 as well as the first embodiment.
After a time point of the next occurrence of an event of the clock timer 52b has passed from the end of the host command processing, the patrol read is continuously executed unless a command from the host 1 is received. In other words, in the second embodiment, resuming of the patrol read is prevented from the end of the host command processing until an event is first generated from the clock timer 52b after the end of the host command processing.

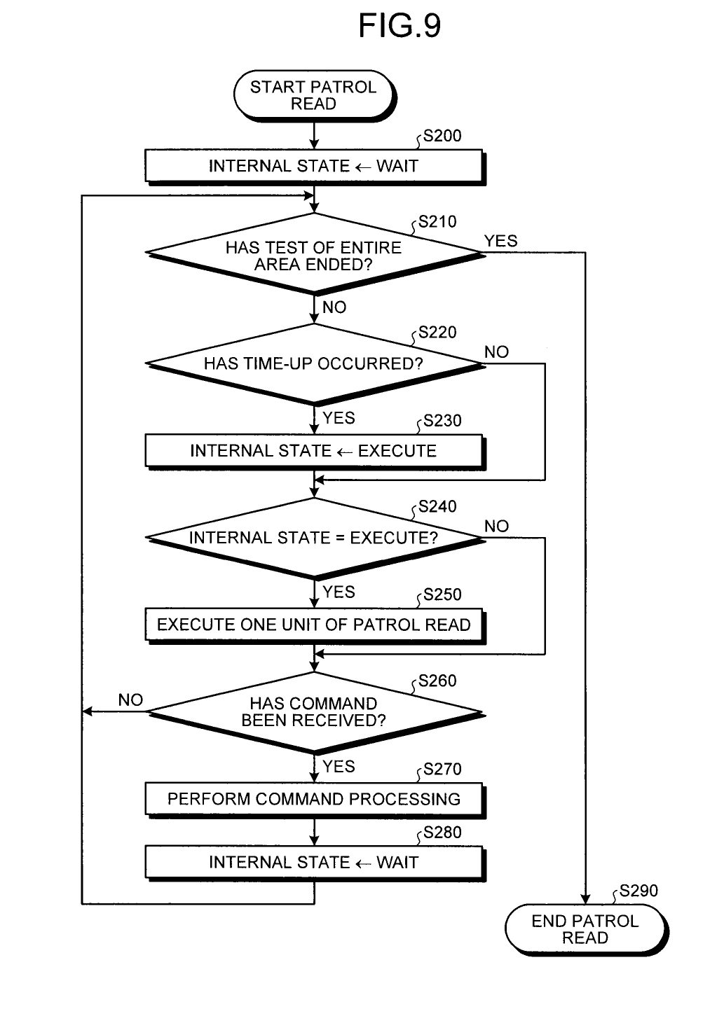

FIG. 9 is a flowchart of an operation procedure performed by the controller 50 in the second embodiment. When the patrol read cycle time Ta is started, the controller 50 sets an internal state of the patrol read to ‘WAIT’ (Step S200). The internal state is set to either ‘WAIT’ or ‘EXECUTE’ which means the execution of patrol read is waiting for the completion of the grace time Te or the execution of patrol read is possible, respectively.

The controller 50 determines whether a test of the entire area of patrol read targets has ended (Step S210) and, when the test of the entire area has not ended, determines whether time-up of the clock timer 52b has occurred (Step S220). Whether the time-up of the clock timer 52b has occurred is determined based on whether the next event I has been generated from the clock timer 52b.

The controller 50 causes the procedure to proceed to Step S240 when the time-up of the clock timer 52b has not occurred, and the controller 50 changes the internal state to ‘EXECUTE’ (Step S230) when the time-up of the timer 52b has occurred.

Whether the internal state is ‘EXECUTE’ is determined at Step S240 and, when the internal state is ‘EXECUTE’, the controller 50 executes one unit of the patrol read (the patrol read corresponding to one page, for example) (Step S250). When the internal state is ‘WAIT’ at Step 240, the procedure is caused to proceed to Step S260.

Whether a command from the host 1 has been received is determined at Step S260 and, when a command has been received, the controller 50 immediately performs command processing (Step S270) and then changes the internal state to ‘WAIT’ (Step S280).

In the second embodiment, when the time-up of the clock timer 52b has not occurred at Step S220, the controller 50 proceeds to No at Step S240 and then determines whether a command from the host 1 has been received (Step S260). When a command from the host 1 has been received (Yes at Step S260), the controller 50 immediately performs the command processing (Step S270) and sets the internal state to ‘WAIT’ after the end of the command processing (Step S280).

When it is determined that no command has been received at Step S260, the controller 50 then repeats a loop of Steps S210, S220, S240, and S260 until the time-up of the timer 52b occurs at Step S220 (until the next event I is generated from the clock timer 52b) or until a command is received at Step S260.

When the time-up of the timer 52b has occurred at Step S220, that is, when the next event I has been generated from the clock timer 52b, the controller 50 changes the internal state to ‘EXECUTE’ (Step S230) and then executes one unit of the patrol read (the patrol read corresponding to one page, for example) (Step S250).

After the patrol read is executed, a loop of the processes at Steps S260, S210, S220, S230, S240, and S250 is repeated with executing of one unit of patrol read each time unless a command is received from the host 1, when the internal state is changed from ‘EXECUTE’ to ‘WAIT’ (Step S230 will also be occasionally executed if the timer 52b generates a next event I).

After the command processing is performed at Step S270, the controller 50 sets the internal state to ‘WAIT’ at Step S280. When a command from the host 1 is received (Step S260) after the end of the command processing at Step S270 and before it is determined that the time-up of the timer 52b has occurred at Step S220 (before the next event I is generated), the controller 50 immediately performs the command processing (Step S270).

When these processes are repeated and thus the patrol read of the entire area of the test targets ends (Step S210), the patrol read of the patrol cycle time ends (Step S290). When the counting of the patrol read cycle time Ta ends before the patrol read of the entire area of the test targets ends, the patrol read of the next period is resumed from the beginning.

As described above, in the second embodiment, resuming of the patrol read is prevented until the next event I is generated after the end of host command processing. Therefore, as shown in FIG. 8, when host commands are continuously received, processing of the host commands can be started without latency times. Furthermore, as shown in FIG. 8, the patrol read is continuously executed as long as a state where no command is received from the host 1 continues. Therefore, the patrol read can be continuously executed without latency times and thus one period of the patrol read can be ended early. In this way, in the second embodiment, latency times of both processes of the command processing and the patrol read can be reduced and the both processes can be performed efficiently. Furthermore, because the timer 52a as a dedicated timer is not required in the second embodiment, the system can be created inexpensively.

In the embodiments described above, the patrol read is executed for an area in which valid data of the storage component 30 is stored. However, the patrol read can be executed for the entire logical address space or the entire physical address space.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory; and
a controller configured to control the nonvolatile memory, wherein
the controller is configured to
perform a process corresponding to a second command when the second command is received from a host device before a first time passes after an end of processing corresponding to a first command received from the host device, and
execute patrol read to read data stored in the nonvolatile memory continuously in predetermined units when no command is received from the host device before the first time passes.

2. The memory system according to claim 1, wherein the first time is a preset fixed time.

3. The memory system according to claim 2, wherein the controller includes a timer that counts the fixed time after the end of the processing corresponding to the first command.

4. The memory system according to claim 1, wherein
the controller has a timer that generates a signal at a predetermined interval, and
the first time is a time from the end of the processing corresponding to the first command until the signal is first generated by the timer after the end of the processing corresponding to the first command.

5. The memory system according to claim 1, wherein, from a start of the patrol read until the first time passes, the controller causes a process of the patrol read that is to be executed next to wait.

6. The memory system according to claim 1, wherein the patrol read is executed for valid data stored in the nonvolatile memory.

7. The memory system according to claim 1, wherein error correction is performed in the patrol read using an error-correcting code attached to the data.

8. The memory system according to claim 7, wherein when the data is corrected using the error-correcting code in the patrol read, the corrected data is written at a storage position different from a storage position at which the data has been stored and the original data is invalidated.

9. The memory system according to claim 1, wherein the nonvolatile memory is a NAND flash memory and the predetermined unit is a page.

10. A method of controlling a memory system including a nonvolatile memory, the method comprising:
performing a process corresponding to a second command when the second command is received from a host device before a first time passes after an end of processing corresponding to a first command received from the host device, and
executing patrol read to read data stored in the nonvolatile memory continuously in predetermined units when no command is received from the host device before the first time passes.

11. The method of controlling a memory system according to claim 10, wherein the first time is a preset fixed time.

12. The method of controlling a memory system according to claim 10, wherein the first time is a time from the end of the processing corresponding to the first command until a signal is first generated from an output of a timer that generates the signal at a predetermined interval after the end of the processing corresponding to the first command.

13. The method of controlling a memory system according to claim 10, further comprising:
Causing, from a start of the patrol read until the first time passes, a process of the patrol read that is to be executed next to wait.

14. The method of controlling a memory system according to claim 10, wherein the patrol read is executed for valid data stored in the nonvolatile memory.

15. The method of controlling a memory system according to claim 10, wherein error correction is performed in the patrol read using an error-correcting code attached to the data.

16. The method of controlling a memory system according to claim 10, wherein when the data is corrected using the error-correcting code in the patrol read, the corrected data is written at a storage position different from a storage position at which the data has been stored and the original data is invalidated.

17. The method of controlling a memory system according to claim 10, wherein the nonvolatile memory is a NAND flash memory and the predetermined unit is a page.
